(19) United States
(12) Patent Application Publication
(10) Pub. No.: US 2025/0375793 A1
(43) Pub. Date: Dec. 11, 2025

(54) SEPARATING APPARATUS AND DOSING APPARATUS FOR SPHERICAL PELLETS

(71) Applicant: Harro Hoefliger Verpackungsmaschinen GmbH, Allmersbach im Tal (DE)

(72) Inventors: Uwe Blum, Allmersbach im Tal (DE); Dieter Haberzettl, Allmersbach im Tal (DE)

(21) Appl. No.: 19/233,972

(22) Filed: Jun. 10, 2025

(30) Foreign Application Priority Data
Jun. 10, 2024 (EP) 24181139.7

(51) Int. Cl. B07B 13/16; B07B 13/04; B65G 47/84

(52) U.S. Cl. CPC B07B 13/16; B07B 13/04; B65G 47/848; B65G 2201/027

(57) ABSTRACT

A separating apparatus is for spherical pellets, in particular for Lyo beads, and a dosing apparatus including a size sorter, a shape sorter and a separating apparatus of this type. The separating apparatus includes a vacuum dosing wheel which can be driven rotationally about a rotational axis, a vacuum source, and a pressure control device. At least one intake opening for the pellets is arranged in a lateral end surface of the vacuum dosing wheel at a radial spacing from the rotational axis. It is possible for a connection of the vacuum source to the intake opening to be switched on and off via the pressure control device. A second positive pressure source is provided which, following the ejector, can be connected to the at least one intake opening in order to blow out the intake opening.

### CROSS-REFERENCE TO RELATED APPLICATIONS

This application claims priority of European patent application no. 24181139.7, filed Jun. 10, 2024, the entire content of which is incorporated herein by reference.

### TECHNICAL FIELD

The disclosure relates to a separating apparatus for spherical pellets, in particular for Lyo beads, and to a dosing apparatus with a separating apparatus of this type.

### BACKGROUND

Many active substances, in particular in the pharmaceutical sector, are stable in aqueous solution only for a short time. In the case of thermally sensitive substances, above all, freeze drying (lyophilization) is a way forward for achieving storable formulations. After deep freezing and dehydration at a strong negative pressure, spherical pellets in pearl form (also called Lyo beads) arise. As a result of the deep freezing, a substantially spherical, porous framework of active substances and excipients remains, which has a low density and a greatly hygroscopic surface which is very large in comparison with the former.

Lyo beads are predestined by their high dissolution rate for parenteral drugs such as vaccines, for example. On account of their storage stability, they are also highly suitable for new diagnostic tools such as lab on a chip systems. The brittle structure of the lyophilizates requires careful handling, however. The Lyo beads which have an average size of from 1.5 to 4.0 millimeters namely react vulnerably to mechanical abrasion and compacting, become electrostatically charged, and have to be processed further in the case of low moisture. Moreover, the Lyo beads have to be dosed individually.

During the production process, undesired size and/or shape tolerances of the as a rule spherical Lyo beads can occur. Lyo beads with diameter differences, flattened portions or small growths therefore have to be rejected as far as possible before dosing.

A further difficulty lies in the structure of the Lyo beads and the consequent properties. As a consequence of the lyophilization, a sponge-like framework with a high porosity comparable to a rigid foam remains. The mechanical resilience of a rigid foam-like structure of this type is low, in particular, with regard to compressive, shear and abrasion strength. At the same time, the ratio of mass to volume is very low. On account of electrostatics, adhesion and/or other binding mechanisms, the Lyo beads tend to adhere to one another and also to other surfaces, with which they come into contact. Only very low inertial forces are up against these adhesive forces, which results in pouring and flowing properties which are difficult overall. In particular, separation without damaging the Lyo beads in the process is difficult under the stated circumstances.

### SUMMARY

It is an object of the disclosure to specify a separating apparatus for spherical pellets, in particular for Lyo beads, which makes a gentle separation of very light and in the process very sensitive specimens possible.

This object is, for example, achieved by a separating apparatus for spherical pellets. The separating apparatus includes: a vacuum dosing wheel configured to be driven rotationally about a rotational axis; a vacuum source; a pressure control device; the vacuum dosing wheel having a lateral end surface; the lateral end surface having at least one intake opening for the pellets arranged in the lateral end surface at a radial spacing from the rotational axis, wherein a connection of the vacuum source to the at least one intake opening is configured to be switched on and off via the pressure control device; and, a second positive pressure source which, following an ejector, is configured to be connected to the at least one intake opening in order to blow out the at least one intake opening.

It is a further object of disclosure to specify a dosing apparatus for spherical pellets, in particular for Lyo beads, which makes reliable sorting of specimens with excessive size deviations and also shape deviations and, moreover, careful single dosing possible.

This object is, for example, achieved by a dosing apparatus for spherical pellets. The dosing apparatus includes: a size sorter; a shape sorter; a separating apparatus for the pellets; the size sorter having two sorting rollers configured to be driven rotationally about a corresponding longitudinal axis and positioned next to one another such that a spacing which varies along the longitudinal axes and is adapted to a predefined target size of the pellets remains between the two sorting rollers; the shape sorter being a vibration conveyor plate inclined with respect to a horizontal direction, the vibration conveyor plate having an upper end, a lower end, and a collecting apparatus arranged in a region of the lower end and configured to forward pellets to the separating apparatus; the separating apparatus including a vacuum dosing wheel configured to be driven rotationally about a rotational axis, a vacuum source, and a pressure control device; the vacuum dosing wheel including a lateral end surface having at least one intake opening for the pellets defined therein at a radial spacing from the rotational axis; wherein a connection of the vacuum source to the intake opening is to be switched on and off via the pressure control device; and, a second positive pressure source being provided which, following an ejector, is configured to be connected to the at least one intake opening in order to blow out the at least one intake opening.

According to the disclosure, a separating apparatus for spherical pellets, in particular for Lyo beads, is provided, the separating apparatus including a vacuum dosing wheel which can be driven rotationally about a rotational axis, a vacuum source, and a pressure control device. At least one intake opening for the pellets is arranged in a lateral end surface of the vacuum dosing wheel at a radial spacing from the rotational axis. In particular, a plurality of intake openings distributed in the circumferential direction are arranged in the lateral end surface. It is possible for a connection of the vacuum source to the intake opening to be switched on and off via the pressure control device.

It has been shown in practice that guiding the sensitive Lyo beads laterally up to the end surface of the vacuum dosing wheel is particularly gentle. Only very low forces are required. There is practically no risk of individual pellets becoming jammed, crushed or ground. The pellets do not have to be forced through circuitous transport paths into any receiving pockets. Adhesion of the pellets at the edges of the intake openings requires only low suction forces. The Lyo beads can be released again by way of forces which are likewise low.

In an embodiment, a rotational axis of the vacuum dosing wheel lies horizontally, the end surface being of planar configuration and lying orthogonally with respect to the rotational axis. As a result, precise attraction or repulsion can be performed solely by negative and positive pressure, respectively, without the weight forces playing a significant role. This additionally results in a slim, narrow overall configuration which, in conjunction with relatively large filling machines, makes a multiple-row separation at only one station possible.

In an embodiment, the pressure control device has a non-corotating control plate which lies parallel to the vacuum dosing wheel, an arcuate control channel connected to the vacuum source being configured in the control plate. The control channel is adapted in terms of its course to the circulating path of the at least one intake opening, a first end of the control channel being situated in the region of a storage container for the pellets, and a second end of the control channel being situated in the region of an ejector for the pellets. The at least one intake opening is connected in a vacuum-transmitting manner on its circulating path along the course of the control channel to the control channel. Precisely operating vacuum control which can be operated even at high speeds is achieved by simple mechanical means while dispensing with switchover valves or the like.

In an embodiment, a first positive pressure source is provided which can be connected in the region of the ejector to the at least one intake opening in order to repel the pellet. As a result, after the vacuum is switched off, a possibly present residual negative pressure can be eliminated, as a result of which positionally accurate falling of the very light pellets exactly at the location of the ejector is assisted.

According to the disclosure, a second positive pressure source is provided which, following the ejector, can be connected to the at least one intake opening in order to blow out the intake opening. As a result, after separation has taken place, cleaning can be performed by blowing out the respective intake opening.

In an embodiment, a gap is provided between the storage container and the vacuum dosing wheel at least in a lower portion. If, despite all the gentle treatment of the pellets, a certain quantity of abrasion or fragments should collect in the storage container, this can fall through the gap without disrupting the regular separating process.

In a further aspect of the disclosure, a dosing apparatus for spherical pellets, in particular for Lyo beads, is provided which includes a size sorter, a shape sorter and a separating apparatus for the pellets. The size sorter has two sorting rollers which can be driven rotationally about their longitudinal axes and which are positioned next to one another in such a way that a spacing which varies along the longitudinal axes and is adapted to a predefined target size of the pellets remains between them. The shape sorter is configured as a vibration conveyor plate, inclined with respect to a horizontal direction, with an upper end, with a lower end, and with a collecting apparatus, arranged in the region of the lower end, for pellets for forwarding to the separating apparatus.

Accordingly, the dosing apparatus according to the disclosure substantially includes three components for the, in particular, sequential fulfillment of three tasks. In the first component, namely in the size sorter, the sorting of pellets which are too small and pellets which are too large takes place. In the second component, namely in the shape sorter, a sorting of pellets which do not have a sufficiently precise spherical configuration takes place. Finally, in the third component, namely in the separating apparatus, the individual dosing of the spherical pellets which have been found to be satisfactory with regard to size and shape takes place.

Here, all three components of the dosing apparatus make use of the sought spherical shape. The pellets are placed onto the upper side of the pair of rotating sorting rollers, these pellets being situated in the region of the gap between the sorting rollers and carrying out a movement along the longitudinal axes of the sorting rollers. The varying spacing which is adapted to a predefined target size of the pellets between the sorting rollers brings it about that only the excessively small pellets fall between the rollers and are rejected in the region of a small roller spacing. In the region of a roller spacing which corresponds to the target size, the pellets with a desired diameter fall through and can be fed for further processing, while excessively large pellets cannot pass the roller gap and are still retained. In the region of a further increased roller spacing, the remaining pellets which have been found to be too large then finally also fall between at the rollers and are therefore rejected just like the pellets which are too small. In particular, the pellets with the target size and the spherical target shape can roll here in a gentle manner on the surfaces of the rotating sorting rollers, these pellets experiencing gentle sorting.

The sought spherical shape likewise comes into play on the vibration conveyor plate of the shape sorter. Pellets with a sufficiently precise spherical configuration roll on the inclined vibration conveyor plate in the direction of the lower end. Practically no tangential forces can arise between the rolling spherical pellets and the surface of the vibration conveyor plate. The rolling operation is, as it were, friction-free and gentle, and the pellets which have been identified in such a way as sufficiently round can be fed free from damage to the separation means. On account of a practically absent transmission of tangential forces, the vibration conveyor plate is not capable of transporting the pellets which are round as desired against their rolling direction toward the upper end, whereby this vibration conveyor plate remains practically without effect as conveying apparatus for these round pellets. This is different in the case of the pellets with a configuration which deviates from the ideal spherical shape. In the case of non-round shapes or even fragments, the rolling movement is impeded or is even impossible. The vibration conveyor plate can apply tangential forces or frictional forces and can convey the non-round pellets toward the upper edge, where they are then rejected.

The pellets which are identified in this way with regard to a suitable size and a sufficiently precise spherical configuration can then finally be dosed in a gentle manner as a single pellet in the abovementioned separating apparatus.

### BRIEF DESCRIPTION OF DRAWINGS

The invention will now be described with reference to the drawings wherein:

FIG. 1 shows a diagrammatic side view of a size sorter as part of the dosing apparatus according to the disclosure with sorting rollers which are inclined relative to the horizontal direction;

FIG. 2 shows a diagrammatic front view of the size sorter according to FIG. 1 with a pair of sorting rollers which rotate on the outside on their upper side in opposite directions;

FIG. 3 shows a diagrammatic plan view of the pair of sorting rollers according to FIG. 2 in a cylindrical embodiment with longitudinal axes which lie at an opening angle with respect to one another in order to form a varying spacing;

FIG. 4 shows one variant of the roller pair according to FIG. 3 with parallel sorting rollers and with a sorting roller with a stepped diameter in order to form the varying spacing;

FIG. 5 shows a diagrammatic side view of a shape sorter as part of the dosing apparatus according to the disclosure with a vibration conveyor plate which is inclined with respect to the horizontal direction;

FIG. 6 shows a diagrammatic side view of a separating apparatus as part of the dosing apparatus according to the disclosure with an obliquely lying, rotationally drivable format disk for receiving individual pellets;

FIG. 7 shows a front view of the format disk according to FIG. 6 with individual receiving holes for the pellets;

FIG. 8 shows one embodiment according to the disclosure of the separating apparatus with a rotationally drivable vacuum dosing wheel, with a vacuum source for sucking in individual pellets, and with a pressure control device;

FIG. 9 shows a front view of the vacuum dosing wheel according to FIG. 8 with intake openings and with an ejector for drawn-in pellets; and,

FIG. 10 shows a front view of the pressure control device according to FIG. 8 for loading the intake openings according to FIG. 9 with negative and positive pressure in sections in a controlled manner.

### DETAILED DESCRIPTION

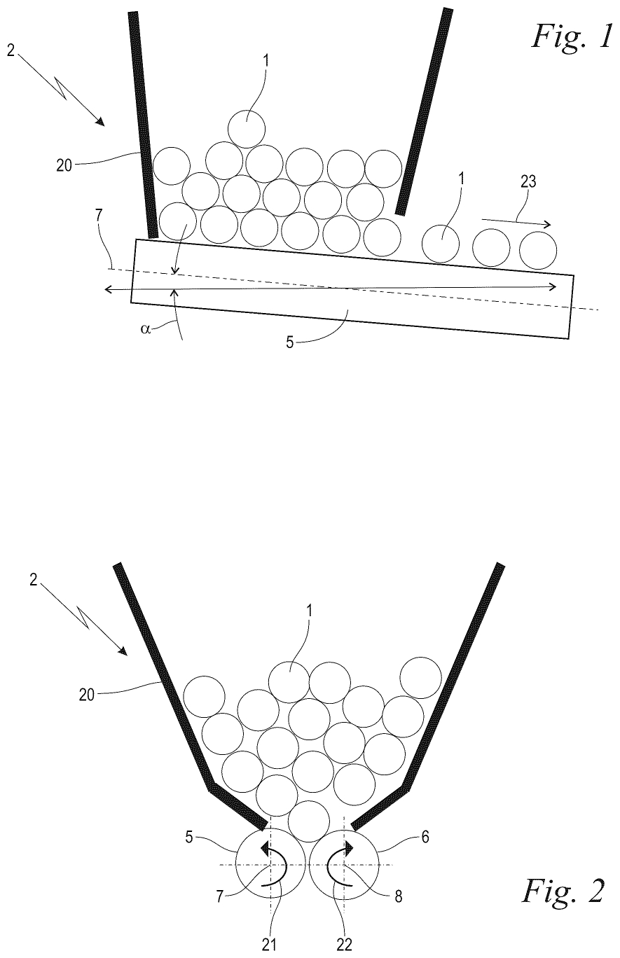

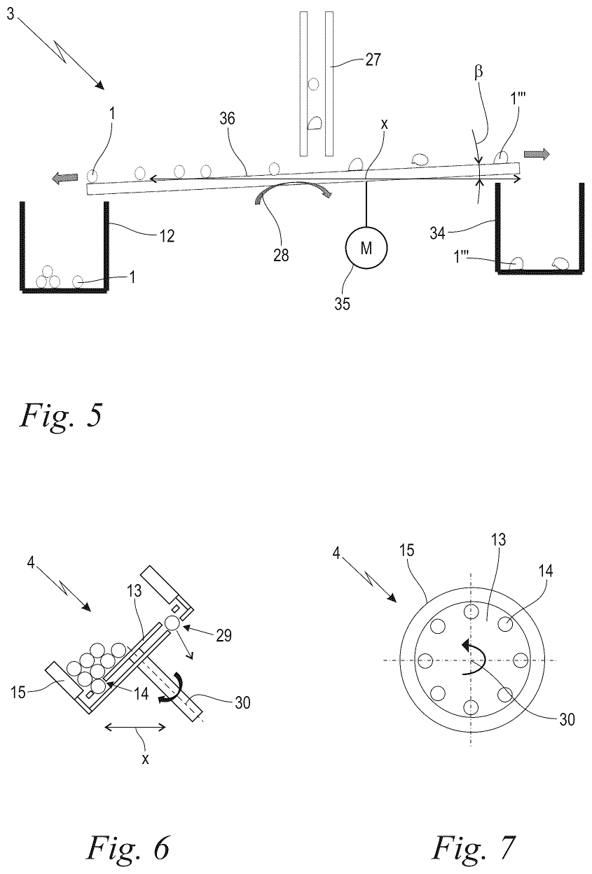

The dosing apparatus according to the disclosure for spherical pellets 1 includes at least three components or functional groups, namely a size sorter 2, for example according to FIGS. 1 to 4, a shape sorter 3 by way of example according to FIG. 5, and a separating apparatus 4 by way of example according to FIGS. 6 to 10. All three components or functional groups are shown individually here for the sake of satisfactory clarity, but in practice can be combined to form a spatially and also functionally integrated apparatus. Here, “spherical” pellets 1 means pellets of this type which have a spatially curved surface and can roll in different directions, whereby, in addition to actual spheres, ellipsoids, oval shapes or shapes with an irregular radius distribution with a given rolling capability are included.

FIG. 1 shows a diagrammatic side view of one embodiment of a size sorter 2. Pellets 1 are provided as bulk material in a container 20 with the aim of separating therefrom those specimens which lie within a defined diameter tolerance and in the process have a sufficiently precise spherical configuration. These round pellets 1 are preferably what are known as Lyo beads obtained by lyophilization. The remaining specimens which are too small, too large or too non-round are to be rejected.

FIG. 2 shows a diagrammatic front view of the size sorter 2 according to FIG. 1. A combined study of FIGS. 1 and 2 results in the fact that a pair of sorting rollers 5, 6 positioned next to one another is arranged below the container 20. The sorting rollers 5, 6 each have a longitudinal axis 7, 8, these sorting rollers being rotationally drivable about these longitudinal axes 7, 8 via a drive unit (not shown) in accordance with arrows 21, 22. Different possibilities come into question for the selection of the rotational direction of the sorting rollers 5, 6. In the embodiment which is shown, in particular, according to FIG. 2, an opposite rotational direction is selected in such a way that the circumferential surfaces of the sorting rollers 5, 6 run apart from one another on their upper side which points upward in the weight force direction, that is, that the circumferential surfaces move away from one another there.

Furthermore, combined study of FIGS. 1 and 2 results in the fact that the longitudinal axes 7, 8 of the two sorting rollers 5, 6 lie at a first inclination angle α>0° with respect to a horizontal direction x. This leads to the upper sides of the sorting rollers 5, 6 lying at a higher level at one end than at the opposite end. The container 20 is arranged in the region of the end which lies at a higher level, with the result that the pellets 1 are placed in the region of this end which lies at a higher level onto the upper side of the sorting rollers 5, 6. It also results from FIG. 2 that the sorting rollers lie close to one another in this region in such a way that the pellets 1 cannot fall between them there. Rather, in this region, the two sorting rollers 5, 6 form a channel, in which the pellets 1 come to lie. The oblique positioning of the longitudinal axes 7, 8 by the first inclination angle α brings about a propulsion which acts on the pellets 1 along the longitudinal direction of the sorting rollers 5, 6 from the higher end toward the lower end. This propulsion brings it about, in conjunction with the rotational movement of the sorting rollers 5, 6, that the pellets move in said channel along an arrow 23 starting from the high end with the container 20 in the direction of the low end of the sorting rollers 5, 6.

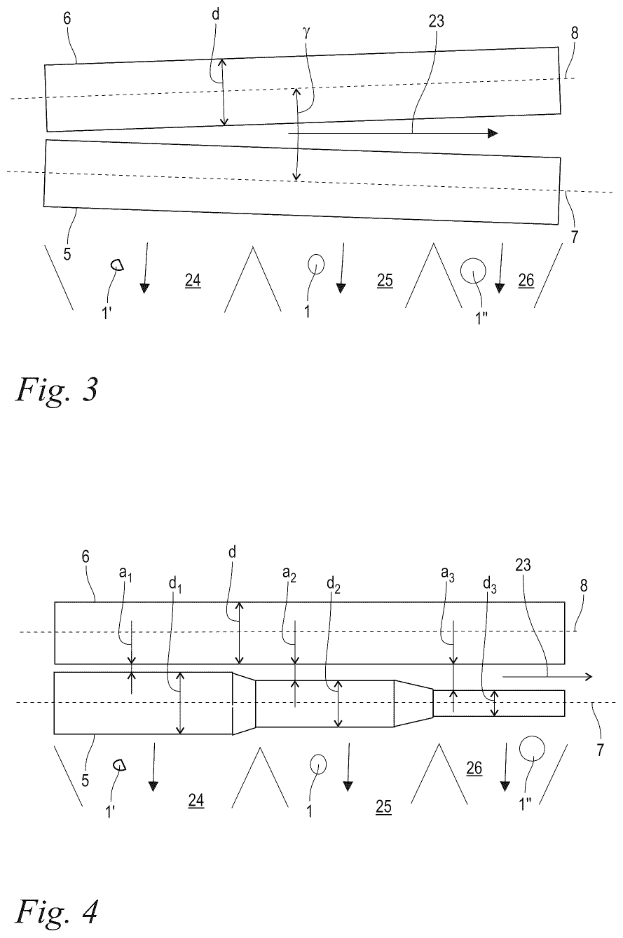

In addition, the sorting rollers 5, 6 are positioned next to one another in such a way that the spacing a, a₁, a₂, a₃ which varies along the longitudinal axes 7, 8 and is adapted to a predefined target size of the pellets 1 remains between them. Therefore, a gap with a correspondingly non-constant width is formed. To this end, FIG. 3 shows a diagrammatic plan view of a first embodiment of a pair of sorting rollers 5, 6 according to FIG. 2. At least one sorting roller 6 is of cylindrical configuration. In the present case, the two sorting rollers 5, 6 are configured in the form of a cylinder with a constant diameter d along their respective longitudinal axis 7, 8. Moreover, the longitudinal axes 7, 8 of the two sorting rollers 5, 6 lie at an opening angle γ>0°, measured in the horizontal plane, in order to generate the varying spacing a. Here, the spacing a varies along the roller longitudinal direction in such a way that it is lowest at the higher end of the sorting rollers 5, 6 in the region of the container 20, becomes continuously larger from there toward the lower end, and is largest in the region of the lower end.

Below the pair of sorting rollers 5, 6, a first collecting portion 24, a second collecting portion 25 and a third collecting portion 26 are situated in the region of the gap formed by the spacing a, which are not shown below but rather next to the sorting rollers 5, 6 in the drawing for reasons of improved clarity. As has already been mentioned further above, the pellets 1 move along the sorting rollers 5, 6 in the gap region in between and in the direction of the arrow 23, as far as possible all the pellets 1 initially lying close to the container 20 in or on the channel formed between the sorting rollers 5, 6. The spacing a becomes greater along the movement course of the pellets 1 in the direction of the arrow 23 to such an extent that first of all small pellets 1′ fall through the gap which is still narrow with a small spacing a between the sorting rollers 5, 6 and are collected in the first collecting portion 24. Larger pellets 1, 1″ are retained by the sorting rollers 5, 6 on their upper side at this location. In the further movement course of these pellets 1, 1″ which are initially still retained, medium-size pellets 1 fall through the gap in the region of the medium-size spacing a and are collected in the second collecting portion 25. In an analogous manner with respect hereto, the even larger pellets 1″ are first of all retained by the sorting rollers 5, 6 in the region of the second collecting portion 25, in order then finally to fall through the gap with a further enlarged spacing a in the further movement course in the direction of the arrow 23 and to be collected in the third collecting portion 26.

Here, the stated varying spacing a is adapted to the target size of the pellets 1 which is predefined by the operator, in such a way that the sorting rollers in the middle region (here, that is, in the region of the second collecting portion 25) allow those pellets 1 to pass and be collected which have a size or diameter within the predefined tolerance range and which have therefore been found to be satisfactory with regard to the “size” criterion. In the same operation, the smaller pellets 1′ which have previously fallen through and the larger pellets 1″ which have subsequently fallen through are rejected as being too small and too large, respectively.

As an alternative, the same effect can also be achieved by a pair of conically tapering sorting rollers 5, 6, parallel orientation of the longitudinal axes 7, 8 being expedient in some circumstances, but a combination with a more or less pronounced opening angle γ also coming into question. Furthermore, the conical shape can be used in conjunction with the first inclination angle α according to FIG. 1. It can also, however, make this inclination angle α superfluous in some circumstances, the above-described propulsion force for the pellets then resulting solely from the cone surface of the sorting rollers 5, 6 which lies obliquely with respect to the horizontal direction x.

FIG. 4 shows a diagrammatic plan view of one variant of the arrangement according to FIG. 3, the two sorting rollers 5, 6 being arranged in the axially parallel manner, that is, with parallel longitudinal axes 7, 8. Despite their parallelism, the longitudinal axes 7, 8 lie at a first inclination angle α>0° relative to the horizontal direction, as shown in FIG. 1. One sorting roller 6 is, as in FIG. 3, of cylindrical configuration with a diameter d which is constant in the active region. In a deviation from this, the other dosing roller 5 has different diameters d₁, d₂, d₃ which are stepped along its longitudinal axis 7 in order to produce the varying spacing a₁, a₂, a₃. In other words, a plurality of (here, three) cylindrical part portions of the sorting roller 5 exist with associated different diameters d₁, d₂, d₃. The part portion with the greatest diameter d₁ leads to a smallest spacing a₁ and, in an analogous manner with respect to the arrangement according to FIG. 3, is situated close to the container 20 and the higher end of the sorting rollers 5, 6. In a further analogy to the embodiment according to FIG. 3, this is followed in the direction of the arrow 23 by the second part portion with the medium-size diameter d₂ and the medium-size spacing a₂ which follows therefrom, which is adjoined toward the lower end by the third part portion with the smallest diameter d₃ and the greatest spacing a₃ which follows therefrom. The method of operation is as in the embodiment according to FIG. 3, pellets 1 with a desired size being allowed to pass in the middle part portion at the middle size spacing a₂ and being connected in the second collecting portion 25 for further processing, while pellets 1′, 1″ with an undersize or oversize are rejected in the outer part portions with the smaller spacing a₁ or with the greater spacing a₃.

FIG. 4 shows the combination of a stepped sorting roller 5 with a cylindrical sorting roller 6. An embodiment with two sorting rollers 5, 6 which both have stepped diameters d₁, d₂, d₃ can also be expedient, however. Moreover, despite the diameter steps, an arrangement of the longitudinal axes 7, 8 at an opening angle α>0° can be expedient. The variants which are shown and/or described correspond to one another in terms of the remaining features and designations.

FIG. 5 shows a diagrammatic side view of a shape sorter 3 for the pellets 1, the shape sorter 3 being connected functionally downstream of the above-described size sorter. That is, sorting of the pellets 1 according to size takes place first of all, the pellets 1 which have been found to be satisfactory with regard to the size subsequently being sorted with regard to their shape. A reversed sequence can also be expedient, however, that is, first of all shape sorting, in particular according to FIG. 5, and then size sorting, in particular according to FIGS. 1 to 4.

The embodiment of the shape sorter 3 according to FIG. 5 includes a vibration conveyor plate 9 which is inclined with respect to the horizontal direction x by a second inclination angle β>0°. It follows from this inclination that the vibration conveyor plate 9 has an upper end 10 and an opposite lower end 11 in relation to the direction of weight force. The vibration conveyor plate 9 includes a plate body 36 which is flat on the upper side, and a vibration drive 35 which is connected to the former (only indicated here for the sake of simplicity). The vibration drive 35 sets the plate body 36 in vibration in a manner known per se according to an arrow 28, in such a way that objects which lie on the upper surface of the plate body 36 are set in motion in a targeted and directed manner. In the present case, the vibration conveyor plate 9 is configured in such a way that objects which lie on it are moved in the direction of the upper end 10 as a consequence of oscillating tangential forces which act on them.

A pellet feed 27 is situated approximately in the middle region of the vibration conveyor plate 9, via which pellet feed the pellets 1 which are classified as satisfactory with regard to size by the size sorter 2 are placed onto the upper surface of the plate body 36. Sufficiently round, spherical specimens of these pellets 1 roll on the surface of the plate body 36 in the direction of the lower end 11 as a consequence of its oblique position and the weight force which acts. The plate body 36 cannot exert any sufficient tangential forces on these rolling pellets 1, with the result that the plate body 36 which is in operation and is driven in an oscillating manner has no sufficient conveying effect in the direction of the upper end 10. The stated sufficiently round, spherical pellets 1 therefore roll to the lower end 11 despite the operation of the vibration conveyor plate 9, and are collected via a collecting apparatus 12 position there as pellets 1 which have been found to be satisfactory with regard to the “roundness” criterion.

Fractures of pellets 1 or pellets 1′″ which are non-round in some other way cannot carry out a pronounced rolling movement of this type on the plate body. The vibration conveyor plate 9 can most certainly exert sufficient tangential forces on them during operation, however, with the result that the stated objects are conveyed toward the upper end 10 counter to the rolling direction, are collected via a collecting apparatus 34 positioned there, and are rejected as lying outside the tolerance with regard to the roundness. By mutual coordination of the vibration drive 35, the surface finish of the plate body 36 and the selection of the second inclination angle β, the tolerance range can be set, within which satisfactory pellets 1 roll toward the lower end 11, and outside which pellets 1′″ which are non-round to an excessively pronounced extent are conveyed toward the upper end 10 and rejected.

The pellets 1 which are collected at the lower end 11 according to the above description are therefore such specimens which lie within the desired tolerance both with regard to the “size” criterion and with regard to the “roundness” criterion. The specimens are subsequently transferred to the separating apparatus 4.

A first embodiment of a separating apparatus 4 of this type is shown in FIGS. 6 and 7, FIG. 6 showing a diagrammatic side view and FIG. 7 showing a diagrammatic plan view thereof. In the embodiment according to FIGS. 6 and 7, the separating apparatus 4 includes a storage container 15 with pellets 1 which are provided therein and accepted as in order by the size sorter 2 and by the shape sorter 3. A bottom of this storage container 15 lies obliquely with respect to the horizontal direction x, the pellets 1 collecting in a lower region of the oblique bottom. In an upper region above the pellet filling level, the bottom is provided with a discharge opening 29. Furthermore, the separating apparatus includes a format disk 13 which is oblique with respect to the horizontal direction x, lies approximately parallel to the bottom of the storage container 15, can be driven rotationally about a rotational axis 30, and is enclosed on the outside by peripheral walls of the storage container 15. According to FIG. 7, the format disk 13 is provided in a manner distributed along its circumference with receiving holes 14, in which in each case precisely one pellet 1 can find space.

During the operation, the format disk 13 dips in the lower region into the supply of pellets 1, in each case one receiving hole 14 receiving in each case one pellet 1. As a consequence of the rotational movement of the format disk 13, these pellets 1 are conveyed sequentially upward. In the moment in which a receiving hole 14 comes into overlap with the discharge opening 29, the respective pellet 1 falls out there, is collected as a pellet 1 which is dosed in a separated manner, and is fed to the next method step (not documented further here) such as, for example, the packaging in a target container.

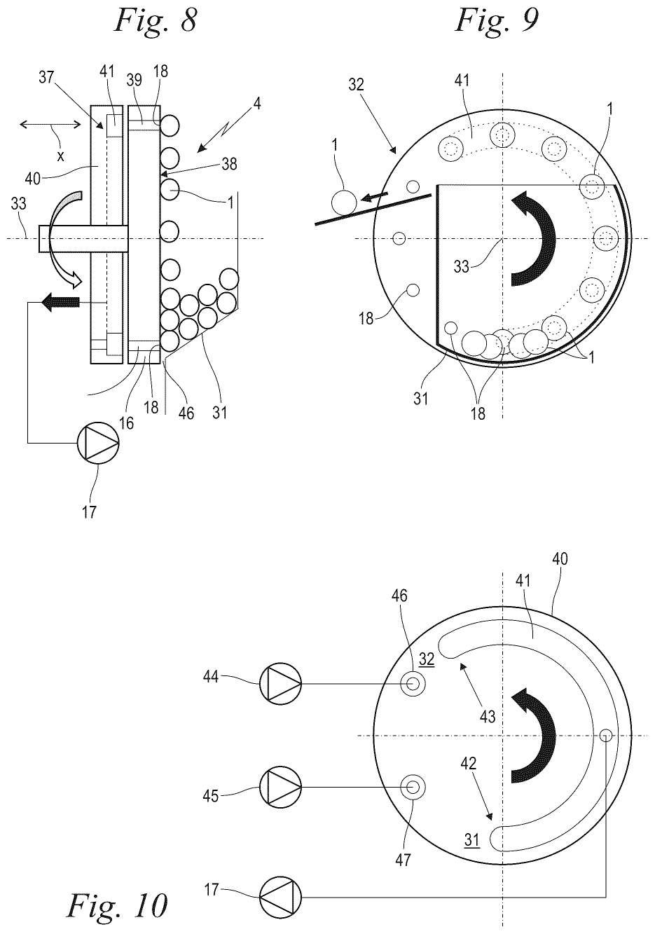

A further embodiment of the separating apparatus 4 as independent construction according to the disclosure or as part of the dosing device according to the disclosure described herein is shown in FIGS. 8, 9 and 10 as an alternative to the separating apparatus 4 of FIGS. 6 and 7, FIG. 8 showing a diagrammatic side view and FIG. 9 showing a diagrammatic plan view. In the embodiment according to FIGS. 8 to 10, the separating apparatus 4 includes a storage container 31 with round spherical pellets 1 which are provided therein, and are accepted as in order by the size sorter 2 and by the shape sorter 3. Furthermore, the separating apparatus 4 includes a vacuum dosing wheel 16 which can be driven rotationally about a rotational axis 33, a vacuum source 17, and a pressure control device 37.

The vacuum dosing wheel 16 is configured here as a cylinder portion with a cylindrical circumferential surface and with a planar end surface 38 which is exposed toward the storage container 31. The storage container 31 is for its part open toward the end surface 38, with the result that the pellets 1 which are stored there as bulk material bear against the end surface 38. A gap 46 is provided between the storage container 31 and the vacuum dosing wheel 16 at least in a lower portion in the weight force direction, through which gap abrasion and possibly present fragments of the pellets 1 can fall downward.

In the embodiment which is shown, the rotational axis 33 lies horizontally, that is, parallel to the horizontal direction x. It can also be inclined slightly with respect to the horizontal direction, however; the inclination angle should preferably not be more than 30° and, in particular, should not be more than 15°. The end surface 38 is configured as a planar circular disk and lies orthogonally with respect to the rotational axis 33. Accordingly, it lies parallel to the weight force direction, but can have a slight inclination angle with respect to the weight force direction in an analogous manner with respect to the rotational axis.

A combined study of FIGS. 8 and 9 results in the fact that the vacuum dosing wheel 16 is provided on its end surface 38 with at least one intake opening, lying at a radial spacing from the rotational axis 33, for the pellets 1. In the present case, a plurality of intake openings 18 are arranged in the lateral end surface 38 and are positioned distributed in the circumferential direction here. The intake opening(s) 18 can be loaded with vacuum or negative pressure by the vacuum source 17, it being possible for a connection of the vacuum source 17 to the intake opening 18 to be switched on and off via the pressure control device 37 in a way which is described in greater detail further below.

The pressure control device 37 includes a control plate 40 which lies parallel to and coaxially with respect to the vacuum dosing wheel 16 and bears in a pressure tight manner there. The control plate 40 is mounted fixedly, that is, does not rotate with the vacuum dosing wheel 16. FIG. 10 shows a diagrammatic front view of this control plate 40. It can be seen from the combined study of FIGS. 8 and 10 that an arcuate control channel 41 which is connected to the vacuum source 17 is configured in the control plate 40. The control channel 41 extends from a first end 42 to a second end 43. The first end 42 of the control channel 41 is situated in the region of the storage container 31 for the pellets 1. The second end 43 of the control channel 41 is situated in the region of an ejector 32 (described in greater detail further below) for the pellets 1. More precisely, the second end 43 lies just in front of the ejector 32 in the rotational direction of the vacuum dosing wheel 16. On account of their radial spacing from the rotational axis 33, the intake openings 18 move in operation on a circulating path about the rotational axis 13. The position and course of the control channel 41 are adapted to this circulating path of the intake openings 18 in such a way that the intake openings 18 pass into overlap with the control channel 41 on their circulating path and in the process are connected in a negative pressure-transmitting manner along the extent of the control channel 41 via bores 39 to the control channel 41.

An optional first channel portion 47 and an optional second channel portion 48 are also situated in the control plate 40. The channel portions 47, 48 can have a longitudinal extent in a comparable manner to the control channel 41 in the circumferential direction. In the present case, they are configured as a simple bore. Just like the control channel 41, the channel portions 47, 48 are adapted to the circulating path of the intake openings 18 in such a way that the intake openings 18 come into overlap with the first and second channel portions 47, 48 on their circulating path and are then connected to them in a positive pressure-transmitting manner via the respective bores 39. In relation to the rotational direction of the vacuum dosing wheel 16, the first channel portion 47 is situated directly at the location of the ejector 32, and is connected in a pressure-transmitting manner to a first optional positive pressure source 44. Following in the rotational direction of the vacuum dosing wheel 16, that is, behind the ejector 32, is situated the second channel portion 48 which is connected in a pressure-transmitting manner to a second optional positive pressure source 45.

During the operation, the vacuum dosing wheel 16 dips in the lower region into the supply of pellets 1. As a consequence of the rotational movement of the vacuum dosing wheel 16, an intake opening 18 which is initially pressureless reaches that first end 42 of the control channel 41 which is situated in the region of the storage container 31, as a result of which the connection of the vacuum source 17 to the stated intake opening 18 is switched on at this location. On account of the negative pressure which then prevails here, a single pellet is sucked in by the intake opening 18. The same applies to each intake opening 18 which follows as a consequence of the rotational movement. A filter material (not shown) or the like can be arranged downstream of the intake opening, for example between the vacuum dosing wheel 16 and the control plate 40, in order to avoid undesired intake of abrasion, fragments or the like. The intake openings 18 have a smaller diameter than the pellets 1, as a consequence of which, from the first end 42, in each case one pellet 1 bears against the edge of in each case one intake opening 18 and is held there by suction force. As a consequence of the rotational movement of the vacuum dosing wheel 16, the intake openings 18 first of all follow the course of the control channel 41, as a result of which the negative pressure loading is maintained. As a consequence, these pellets 1 initially remain adhering to the intake openings 18 and are conveyed upwards sequentially. There, they reach the abovementioned, diagrammatically indicated ejector 32. The second end 43 of the control channel 41 is situated in the region of influence of the ejector 32, more precisely just before the ejector 32 is reached. When this second end 43 is overshot, the intake openings 18 lose their connection to the control channel 41 and therefore to the negative pressure source 17. In other words, the vacuum supply of the respective intake opening 18 or the connection of the vacuum source 17 to the intake opening 18 is interrupted or switched off individually. As a consequence, the respective pellet 1 falls in the region of the ejector 32 from the associated intake opening 18. Directly at the ejector 32, the respective intake opening passes into overlap with the first channel portion 47. As a result, in addition to the vacuum being switched off, a small positive pressure surge can be output to the intake opening 18, in order to eliminate a residual vacuum which is possibly present there, and in order to assist releasing the pellet 1 from the edge of the intake opening 18.

In any case, the falling pellet 1 is collected via the ejector 32, is ejected from the separating apparatus 4, and is fed as a pellet 1 which is dosed in a separated manner, just like in the embodiment according to FIGS. 6 and 7, to the next method step (not documented further here) such as, for example, the packaging in a target container.

As a consequence of the continuous further rotation of the vacuum dosing wheel 16, the individual intake openings 18 finally pass into the region of action of the second channel portion 48. Via the pressure-transmitting connection established here to the second positive pressure source 45, a positive pressure surge can be output to the respective intake opening 18, for example for cleaning purposes, in order to blow out abrasion or fragments of the pellets 1, for example.

It is understood that the foregoing description is that of the preferred embodiments of the invention and that various changes and modifications may be made thereto without departing from the spirit and scope of the invention as defined in the appended claims.

1. A separating apparatus for spherical pellets, the separating apparatus comprising:
a vacuum dosing wheel configured to be driven rotationally about a rotational axis;
a vacuum source;
a pressure control device;
said vacuum dosing wheel having a lateral end surface;
said lateral end surface having at least one intake opening for the pellets arranged in said lateral end surface at a radial spacing from the rotational axis, wherein a connection of said vacuum source to said at least one intake opening is configured to be switched on and off via said pressure control device; and,
a second positive pressure source which, following an ejector, is configured to be connected to said at least one intake opening in order to blow out said at least one intake opening.

2. The separating apparatus of claim 1, wherein said lateral end surface has a plurality of said at least one intake openings distributed in a circumferential direction arranged in said lateral end surface.

3. The separating apparatus of claim 1, wherein the rotational axis of the vacuum dosing wheel lies horizontally; and, said lateral end surface is of planar configuration and lies orthogonally with respect to the rotational axis.

4. The separating apparatus of claim 1, wherein said pressure control device has a non-co-rotating control plate which lies parallel to said vacuum dosing wheel, an arcuate control channel which is adapted in terms of a course to a circulating path of said at least one intake opening and is connected to said vacuum source being configured in said non-co-rotating control plate, a first end of the control channel is disposed in a region of a storage container for the pellets, a second end of the control channel is disposed in a region of the ejector for the pellets, and said at least one intake opening is connected in a vacuum-transmitting manner along the course of said control channel to said control channel.

5. The separating apparatus of claim 1 further comprising a first positive pressure source configured to be connected in a region of the ejector to said at least one intake opening in order to repel the pellets.

6. The separating apparatus of claim 1, wherein a gap is defined between a storage container and said vacuum dosing wheel at least in a lower portion.

7. The separating apparatus of claim 1, wherein the spherical pellets are Lyo beads.

8. A dosing apparatus for spherical pellets, the dosing apparatus comprising:
a size sorter;
a shape sorter;
a separating apparatus for the pellets;
said size sorter having two sorting rollers configured to be driven rotationally about a corresponding longitudinal axis and positioned next to one another such that a spacing which varies along the longitudinal axes and is adapted to a predefined target size of the pellets remains between said two sorting rollers;
said shape sorter being a vibration conveyor plate inclined with respect to a horizontal direction, said vibration conveyor plate having an upper end, a lower end, and a collecting apparatus arranged in a region of said lower end and configured to forward pellets to said separating apparatus;
said separating apparatus including a vacuum dosing wheel configured to be driven rotationally about a rotational axis, a vacuum source, and a pressure control device;
said vacuum dosing wheel including a lateral end surface having at least one intake opening for the pellets defined therein at a radial spacing from the rotational axis;
wherein a connection of said vacuum source to said intake opening is to be switched on and off via said pressure control device; and,
a second positive pressure source being provided which, following an ejector, is configured to be connected to said at least one intake opening in order to blow out said at least one intake opening.
